(19) United States
(12) Patent Application Publication
(10) Pub. No.: US 2009/0240494 A1
(43) Pub. Date: Sep. 24, 2009

(54) VOICE ENCODING DEVICE AND VOICE ENCODING METHOD

(75) Inventor: Toshiyuki Morii, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/306,750

(22) PCT Filed: Jun. 28, 2007
(86) PCT No.: PCT/JP2007/063038

§ 371 Date: Dec. 29, 2008

(30) Foreign Application Priority Data
Jun. 29, 2006 (JP) 2006-180143

(51) Int. Cl. G10L 19/10; G10L 19/08

(52) U.S. Cl. 704/223; 704/219; 704/E19.024

(57) ABSTRACT

Provided is a voice encoding device which performs voice encoding by a fixed code book effectively using a bit. In the voice encoding device, a position/polarity calculation unit (205) in a search loop (204) calculates a pulse position and polarity by using values of yH and HH. Moreover, a correlation value/sound source power calculation unit (206) extracts the value of the pulse position calculated by the position/polarity calculation unit (205) using yH and HH and calculates the correlation value and the sound source power. A search loop (207) successively calculates a position, polarity, a correlation value, and a sound source power of other pulses by using the pulse position and the polarity calculated by the position/polarity calculation unit (205) and the correlation value and the sound source power calculated by the correlation value/sound source power calculation unit (206). A large/small judging unit (208) compares a correlation value calculated by the search loop (207) to the value of function C obtained by using the sound source power and searches for a combination of the pulse positions largest in the entire search loop (204).

### TECHNICAL FIELD

The present invention relates to a speech coding apparatus and speech coding method for performing a fixed codebook search.

### BACKGROUND ART

In mobile communication, compression coding for digital information about speech and images is essential for efficient use of transmission bands. Here, expectations for speech codec (coding and decoding) techniques widely used for mobile phones are high, and further improvement of sound quality is demanded for conventional high-efficiency coding of high compression performance.

Up till now, studies are underway for standardization of scalable codec having a multilayer configuration in, for example, ITU-T and MPEG, and more efficient and higher quality speech codec is demanded.

The performance of speech coding techniques, which have improved significantly by the basic scheme “CELP (Code Excited Linear Prediction),” modeling the vocal system of speech and adopting vector quantization skillfully, is further improved by fixed excitation techniques using a small number of pulses, such as the algebraic codebook disclosed in Non-Patent Document 1. Further, there are techniques of realizing higher sound quality by coding that is applicable to a noise level and voiced or unvoiced speech.

However, in coding with a fixed codebook using a small number of pulses such as the algebraic coding disclosed in Non-Patent Document 1, the number of assigned bits needs to be decreased to reduce the bit rate. When the number of assigned bits decreases, the bits assigned to each channel are limited, and, consequently, there are positions in which pulses do not occur, which causes sound quality degradation.

As a countermeasure against this problem, Patent Document 1 discloses a technique of associating excitation waveform candidates of fixed excitations (stochastic excitation) including a plurality of channels, with excitation waveform candidates of different channels, and using the code of an excitation waveform searched for by a predetermined algorithm as the excitation code of the fixed codebook. By this means, it is possible to eliminate positions in which pulses do not occur, while reducing the number of bits upon encoding fixed codebook pulses.

Further, Patent Document 1 discloses a method of changing an excitation waveform candidate of the inner search loop according to an excitation waveform candidate of the outer search loop, and a method of finding pulse positions according to a residue calculation result.
Patent Document 1: Japanese Patent Application Laid-Open No. 2004-163737
Non-Patent Document 1: Salami, Laflamme, Adoul, “8 kbit/s CELP Coding of Speech with 10 ms Speech-Frame: a Candidate for CCITT Standardization,” IEEE Proc. ICASSP94, pp. II-97n

### DISCLOSURE OF INVENTION

### Problem to be Solved by the Invention

However, the above-noted technique disclosed in Patent Document 1 merely relates to a method of using residue and position information, and does not take into account the method of codebook design when the number of bits further decreases. Further, recently, the allowed bit rate of each enhancement section is low to secure the granularity (i.e., bit intervals in the bit rate) in scalable codec that is studied for standardization (in ITU-T and M-PEG), and therefore demands increase for taking into account the method of codebook design when the number of bits decreases.

Taking into account such a presumption, the sufficient number of pulses needs to be provided even if the number of bits that can be distributed for coding in a fixed codebook is very small, and pulses that occur in all predetermined positions in subframes need to be secured. Consequently, providing a fixed codebook that efficiently uses bits is a major goal in speech codec.

It is therefore an object of the present invention to provide a speech coding apparatus and speech coding method for performing speech coding by a fixed codebook that efficiently uses bits.

### Means for Solving the Problem

The speech coding apparatus of the present invention for encoding by a fixed codebook an excitation including a plurality of channels, employs a configuration having: a first search section that searches for an excitation candidate of a first channel; and a second search section that searches for an excitation candidate of a second channel using position information and polarity information of the searched excitation candidate of the first channel.

The speech coding method of the present invention for encoding by a fixed codebook an excitation including a plurality of channels, employs the steps including: a first search step of searching for an excitation candidate of a first channel; and a second search step of searching for an excitation candidate of a second channel using position information and polarity information of the searched excitation candidate of the first channel.

### Advantageous Effect of the Invention

According to the present invention, it is possible to perform speech coding by a fixed codebook that efficiently uses bits.

### BRIEF DESCRIPTION OF DRAWINGS

FIG. 1 is a block diagram showing a configuration of a CELP coding apparatus according to an embodiment of the present invention;

FIG. 2 is a block diagram showing a configuration inside the distortion minimizing section shown in FIG. 1;

FIG. 3 is a block diagrams showing a configuration inside the search loop shown in FIG. 2;

FIG. 4 illustrates relationships between positions and polarities;

FIG. 5 is a flowchart showing steps of fixed codebook search processing; and

FIG. 6 is a flowchart showing steps of fixed codebook search processing.

### BEST MODE FOR CARRYING OUT THE INVENTION

An embodiment of the present invention will be explained below in detail with reference to the accompanying drawings.

### Embodiment

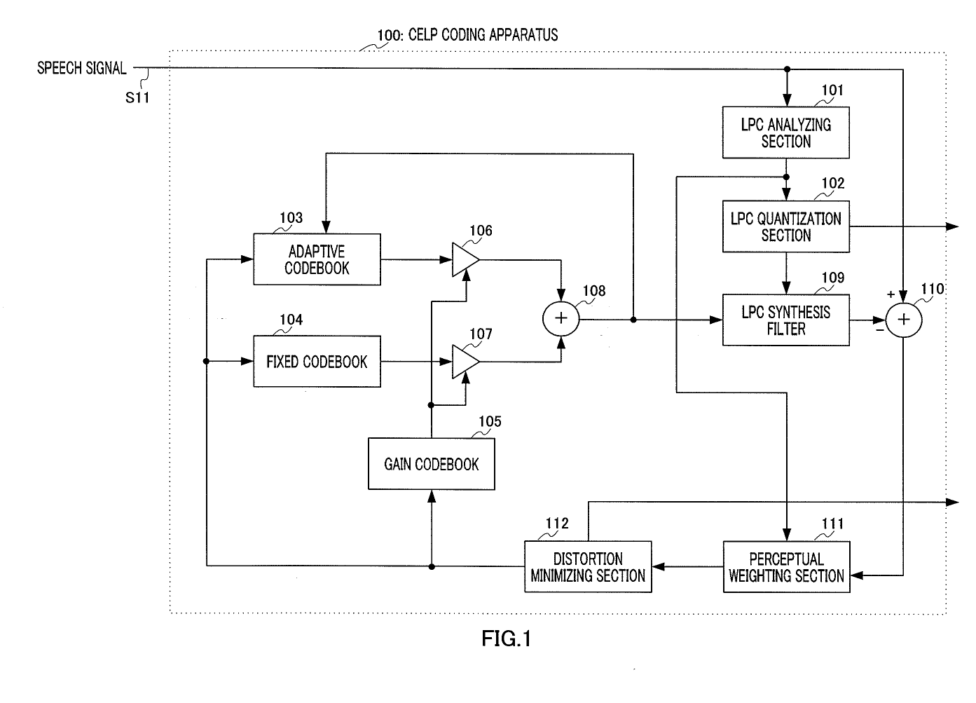

FIG. 1 is a block diagram showing the configuration of CELP coding apparatus 100 according to an embodiment of the present invention. Speech signal S11 is comprised of vocal tract information and excitation information. CELP coding apparatus 100 encodes the vocal tract information of speech signal S11 by finding LPC (Linear Prediction Coefficient) parameters. Further, CELP coding apparatus 100 encodes the excitation information of speech signal S11 by finding an index specifying which speech model stored in advance to use, that is, by finding an index specifying what excitation vector (code vector) to generate in adaptive codebook 103 and fixed codebook 104.

To be more specific, the sections of CELP coding apparatus 100 perform the following operations.

LPC analyzing section 101 performs a linear prediction analysis of speech signal S11, finds an LPC parameter that is spectrum envelope information and outputs the LPC parameter to LPC quantization section 102 and auditory weighting section 111.

LPC quantization section 102 quantizes the LPC parameter outputted from LPC analyzing section 101, and outputs the acquired quantized LPC parameter to LPC synthesis filter 109 and an index of the quantized LPC parameter to outside CELP coding section 100.

Adaptive codebook 103 stores the past excitations used in LPC synthesis filter 109. Further, adaptive codebook 103 generates an excitation vector of one subframe from the stored excitations according to the adaptive codebook lag associated with the index designated from distortion minimizing section 112 that is described later. This excitation vector is outputted to multiplier 106 as an adaptive codebook vector.

Fixed codebook 104 stores in advance a plurality of excitation vectors of a predetermined shape. Further, fixed codebook 104 outputs an excitation vector associated with the index designated from distortion minimizing section 112, to multiplier 107, as a fixed codebook vector. Here, fixed codebook 104 is an algebraic codebook, and a case will be explained where an algebraic codebook is used.

An algebraic excitation is adopted in many standard codecs, in which a small number of impulses that have a magnitude of 1 and that represent information only by their positions and polarities, occur (i.e., + and −). For example, this is disclosed in chapter 5.3.1.9. of section 5.3 “CS-ACELP” and chapter 5.4.3.7 of section 5.4 “ACELP” in the ARIB standard “RCR STD-27K.”

Further, above adaptive codebook 103 is used to represent more periodic components like voiced speech, while fixed codebook 104 is used to represent less periodic components like white noise.

According to the command from distortion minimizing section 112, gain codebook 105 generates and outputs a gain for the adaptive codebook vector that is outputted from adaptive codebook 103 (i.e., adaptive codebook gain) and a gain for the fixed codebook vector that is outputted from fixed codebook 104 (i.e., fixed codebook gain), to multipliers 106 and 107, respectively.

Multiplier 106 multiplies the adaptive codebook vector outputted from adaptive codebook 103 by the adaptive codebook gain outputted from gain codebook 105, and outputs the result to adder 108.

Multiplier 107 multiplies the fixed codebook vector outputted from fixed codebook 104 by the fixed codebook gain outputted from gain 105, and outputs the result to adder 108.

Adder 108 adds the adaptive codebook vector outputted from multiplier 106 and the fixed codebook vector outputted from multiplier 107, and outputs the added excitation vector to LPC synthesis filter 109 as an excitation.

LPC synthesis filter 109 generates a synthesis signal using a filter function including the quantized LPC parameter outputted from LPC quantization section 102 as the filter coefficient and the excitation vectors generated in adaptive codebook 103 and fixed codebook 104 as an excitation, that is, using an LPC synthesis filter. This synthesis signal is outputted to adder 110.

Adder 110 finds an error signal by subtracting the synthesis signal generated in LPC synthesis filter 109 from speech signal S11, and outputs this error signal to perceptual weighting section 111. Here, this error signal is equivalent to coding distortion.

Perceptual weighting section 111 performs perceptual-weighting for the coding distortion outputted from adder 110, and outputs the result to distortion minimizing section 112.

Distortion minimizing section 112 finds the indexes of adaptive codebook 103, fixed codebook 104 and gain codebook 105, on a per subframe basis, such that the coding distortion outputted from perceptual weighting section 111 is minimized, and outputs these indexes to outside CELP coding apparatus 100 as coding information. To be more specific, distortion minimizing section 112 generates a synthesis signal based on above-noted adaptive codebook 103 and fixed codebook 104. A series of processing to find the coding distortion of this signal forms closed-loop control (feedback control). Further, distortion minimizing section 112 searches the codebooks by variously changing the index designated for each codebook in one subframe, and outputs the finally acquired index minimizing the coding distortion for each codebook.

Further, the excitation upon minimizing the coding distortion is fed back to adaptive codebook 103 on a per subframe basis. Adaptive codebook 103 updates stored excitations by this feedback.

The method of searching fixed codebook 104 will be explained below. First, search for an excitation vector and finding a code are performed by searching for an excitation vector to minimize the coding distortion in following equation 1.

[1]

E=|x−(pHa+qHs)|² (Equation 1)

where:

E: coding distortion;

x: coding target;

p: gain of an adaptive codebook vector;

H: perceptual weighting synthesis filter;

a: adaptive codebook vector;

q: gain of a fixed codebook; and

a: fixed codebook vector

Generally, an adaptive codebook vector and a fixed codebook vector are searched for in open-loops (separate loops), and, consequently, finding the code of adaptive codebook vector 104 is performed by searching for the fixed codebook vector minimizing the coding distortion shown in following equation 2.

[2]

$$y = x - pHa \\ E = {\vert y - qHs \vert}^{2} \qquad ( Equation 2 )$$

where:

E: coding distortion

x: coding target (perceptual weighted speech signal);

p: optimal gain of an adaptive codebook vector;

H: perceptual weighting synthesis filter;

a: adaptive codebook vector;

q: gain of a fixed codebook;

s: fixed codebook vector; and

y: target vector in a fixed codebook search

Here, gains p and q are determined after an excitation code is searched for, and, consequently, a search is performed using optimal gains. As a result, above equation 2 can be expressed by following equation 3.

[3]

$$y = x - \frac{x \cdot Ha}{{\vert Ha \vert}^{2}} Ha \\ E = {\vert y - \frac{y \cdot Hs}{{\vert Hs \vert}^{2}} Hs \vert}^{2} \qquad ( Equation 3 )$$

Further, minimizing this equation for distortion is equivalent to maximizing function C in following equation 4.

[4]

$$C = \frac{{( yH \cdot s )}^{2}}{sHHs} \qquad ( Equation 4 )$$

Therefore, to search for an excitation comprised of a small number of pulses such as an algebraic codebook excitation, it is possible to calculate the above function C with a small amount of calculations by calculating yH and HH in advance.

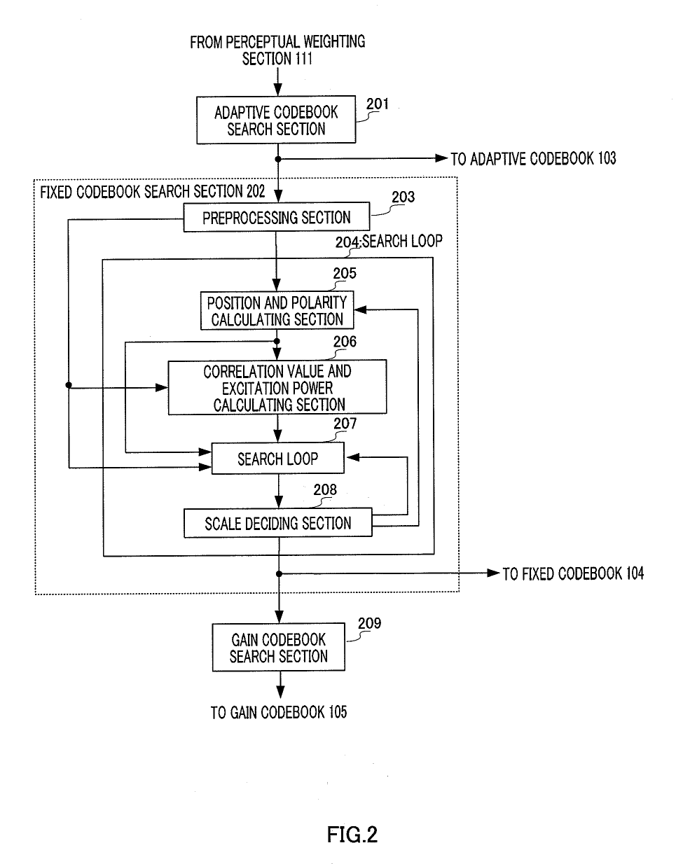

FIG. 2 is a block diagram showing the configuration inside distortion minimizing section 112 shown in FIG. 1. This figure shows a case where there are two search loops of a fixed codebook of five pulses.

In FIG. 2, adaptive codebook searching section 201 searches for adaptive codebook 103 using the coding distortion subjected to perceptual weighting in perceptual weighting section 111. As a search result, the code of the adaptive codebook vector is outputted to preprocessing section 203 in fixed codebook searching section 202 and to adaptive codebook 103.

Preprocessing section 203 in fixed codebook searching section 202 calculates vector yH and matrix HH using the coefficient H of the synthesis filter in perceptual weighting section 111. yH is calculated by convoluting matrix H with reversed target vector y and further reversing the result of the convolution. HH is calculated by multiplying the matrixes.

Further, preprocessing section 203 determines in advance the polarities (+ and −) of the pulses from the polarities of the elements of vector yH. To be more specific, the polarities of pulses that occur in respective positions are coordinated with the polarities of the values of yH in those positions, and the polarities of the yH values are stored in a different sequence. After the polarities in these positions are stored in the different sequence, the yH values are all made absolute values, that is, the yH values are converted into positive values. Further, the polarities of the HH values are converted in coordination with the stored polarities of those positions. The calculated yH and HH are outputted to polarity calculating section 205, correlation value and excitation power calculating section 206 and search loop 207 in search loop 204.

Search loop 204 is configured with position and polarity calculating section 205, correlation value and excitation power calculating section 206, search loop 207 and scale deciding section 208.

Position and polarity calculating section 205 calculates a pulse position using the outputted yH values and HH values, and calculates the polarity of this pulse based on the calculated pulse position. The calculated pulse position and polarity are outputted to correlation value and excitation power calculating section 206 and search loop 207.

Correlation value and excitation power calculating section 206 acquires the value at the pulse position calculated in position and polarity calculating section 205 using the yH and HH outputted from preprocessing section 203, and calculates correlation value sy0 and excitation power sh0. These calculated correlation value sy0 and excitation power sh0 are outputted to search loop 207.

Search loop 207, which is the search loop in search loop 204, calculates in order from positions, polarities, correlation values and excitation power of other pulses using the pulse position and its polarity outputted from position and polarity calculating section 205 and correlation value sy0 and excitation power sh0 outputted from correlation value and excitation power calculating section 206. To be more specific, position and polarity calculating section 205 and correlation value and excitation power calculating section 206 perform calculations for the pulse of channel 0, and search loop 207 calculates the position, polarity, correlation value and excitation power of the pulse of channel 1 using the calculation result of the pulse of channel 0, and performs a calculation in the same way as above for the pulse of channel 2 using the calculation result of the pulse of channel 1. Thus, the position, polarity, correlation value and excitation power of the lower-channel pulse are calculated in order using the calculation result of the higher-channel pulse. However, in the present embodiment, there is no position code after the third pulse, and therefore pulse positions after the third pulse are calculated from the position and polarity information of the higher-channel pulse. Function C is calculated using the finally calculated correlation value and excitation power, and outputted to scale deciding section 208. Further, search loop 207 will be described later in detail.

Scale deciding section 208 compares the scales of the values of function C outputted from search loop 207, and overwrites and stores the numerator and denominator of function C of the highest value. Further, scale deciding section 208 searches for the combination of pulse positions to maximize function C in search loop 204. Scale deciding section 208 combines the code of each pulse position and the code of the polarity of each pulse position to find the code of the fixed codebook vector, and outputs this code to fixed codebook 104 and gain codebook search section 209.

Gain codebook search section 209 searches for the gain codebook based on the code of the fixed codebook vector combining the code of each pulse position and the code of the polarity of each pulse position outputted from scale deciding section 208, and outputs the search result to gain codebook 105.

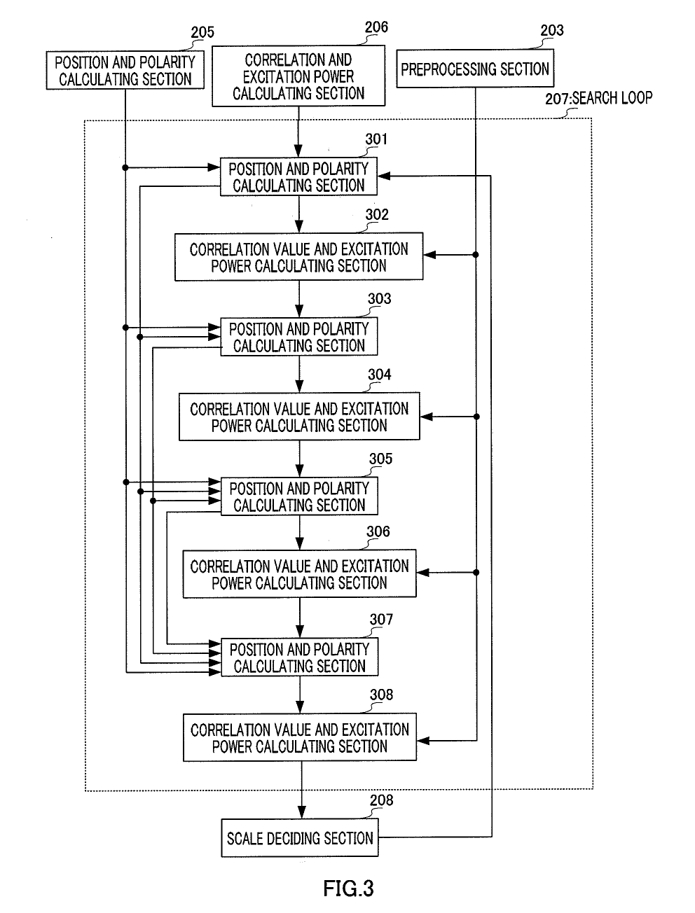

FIG. 3 is a block diagram showing the configuration inside search loop 207 shown in FIG. 2. In this figure, position and polarity calculating section 301 calculates the position and polarity of the second pulse based on the pulse position and polarity outputted from position and polarity calculating section 205 and the correlation value sy0 and excitation power sh0 outputted from correlation value calculating section 206. The calculated pulse position and polarity of the second pulse are outputted to correlation value and excitation power calculating section 302, and position and polarity calculating sections 303, 305 and 307.

Correlation value and excitation power calculating section 302 finds the value of the pulse position calculated in position and polarity calculating section 301 using the yH and HH outputted from preprocessing section 203, and calculates correlation value sy1 and excitation power sh1. The calculated correlation value sy1 and excitation power sh1 are outputted to position and polarity calculating section 303.

As in the above-noted processing, position and polarity calculating section 303 and correlation value and excitation power calculating section 304 calculate the position, polarity, correlation value sy2 and excitation power sh2 of the third pulse. Further, as in the above-noted processing, position and polarity calculating section 305 and correlation value and excitation power calculating section 306 calculate the position, polarity, correlation value sy3 and excitation power sh3 of the fourth pulse. Further, as in the above-noted processing, position and polarity calculating section 307 and correlation value and excitation power calculating section 308 calculate the position, polarity, correlation value sy4 and excitation power sh4 of the fifth pulse.

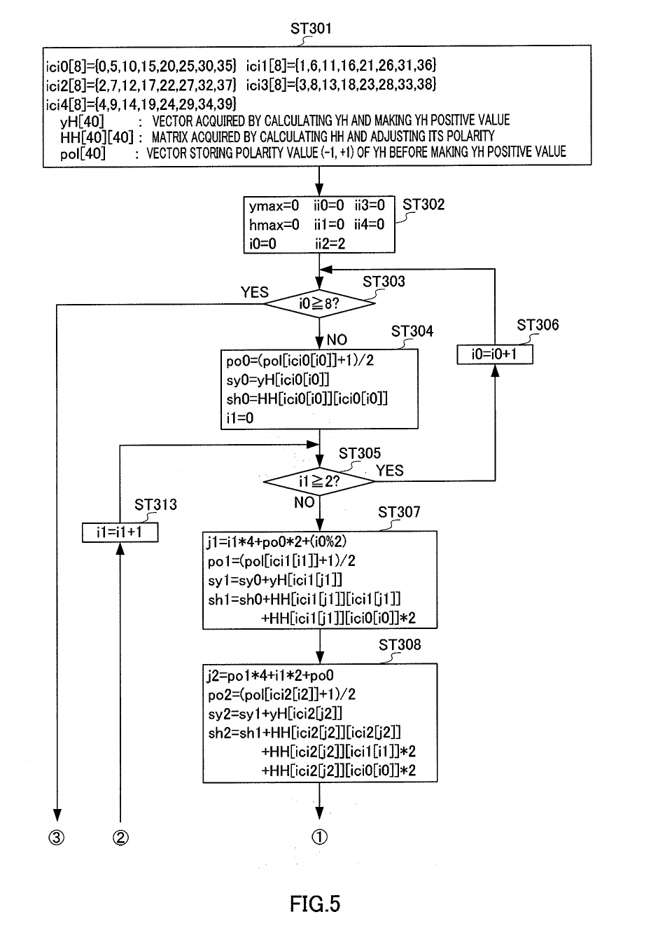

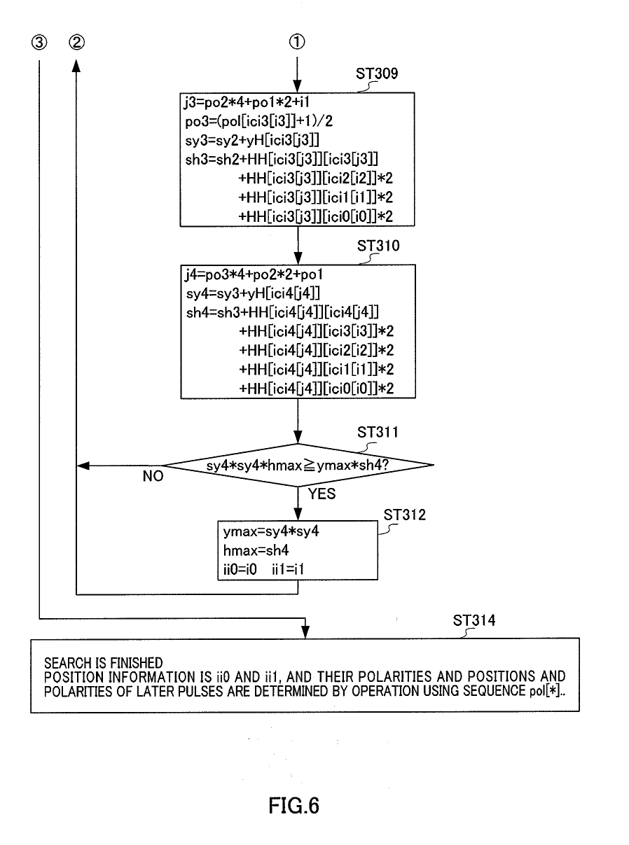

FIGS. 5 and 6 illustrate a series of steps of processing in fixed codebook search section 202 in detail. Further, the parameters of an algebraic codebook are shown below.
1. the number of bits: nine bits
2. unit of processing (subframe length): forty
3. the number of pulses: five

With these parameters, as an example, it is possible to design the following algebraic codebook where a single pulse is secured to occur in all predetermined positions in the subframe.
(position candidates of codebook (the number of pulses is five)
ici0[8]={0, 5, 10, 15, 20, 25, 30, 35}
ici1[8]={1, 6, 11, 16, 21, 26, 31, 36}
ici2[8]={2, 7, 12, 17, 22, 27, 32, 37}
ici3[8]={3, 8, 13, 18, 23, 28, 33, 38}

ici4[8]={4, 9, 14, 19, 24, 29, 34, 39}

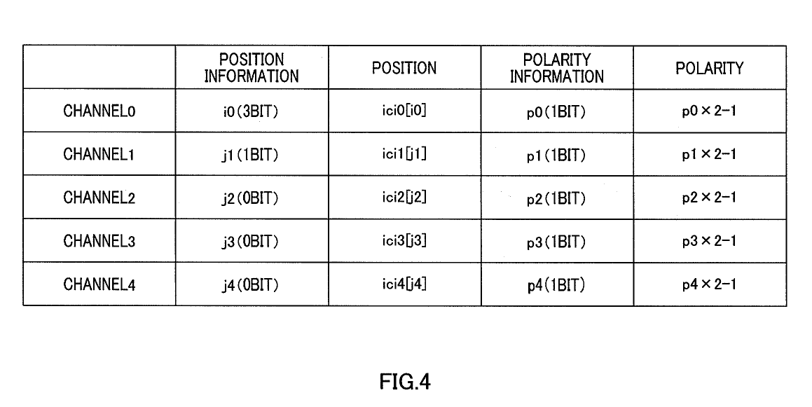

However, the position information, position, polarity information and polarity of each channel (channels 0 to 4) are as shown in FIG. 4. In this case, a calculation example of position information (j1 to j4) will be shown below.
j1=i1×4+p0×2+i0 % 2
j2=p1×4+i1×2+p0
j3=p2×4+p1×2+i1
j4=p3×4+p2×2+p1

However, “%” in the above-noted calculation example shows a computation of calculating the residue upon dividing i0 by two.

In FIGS. 5 and 6, position candidates in the codebook are set in ST301, initialization is performed in ST302, and whether i0 is less than eight is checked in ST303. If i0 is less than eight, position information is calculated, the polarity information of the calculated position information is calculated, the first pulse positions in the codebook are outputted to calculate the values using yH and HH, as the correlation value sy0 and the excitation power sh0 (ST304). This calculation is repeated until i0 reaches eight (which is the number of pulse position candidates) (ST303 to ST306).

By contrast, when i0 is less than eight, if i1 is less than two, processing in ST305 to ST313 are repeated. In this processing, as for the calculation of a single i0, position information is calculated, polarity information of the position information is calculated, the second pulse positions in codebook 0 are outputted to calculate the values of yH and HH, and correlation value sy0 and excitation power sh0 are added to these calculated values, respectively, to calculate correlation value sy1 and power sh1 (ST307).

Further, the position information and polarity information of the lower-channel pulses are calculated from the calculated position information and polarity information of the higher-channel pulses, and the third to fifth pulse positions are outputted to calculate the values using yH and HH, as the correlation values sy2 to sy4 and the excitation power sh2 to sh4.

The values of function C are compared using correlation value sy4 and power sh4 calculated in ST310 (ST311), and the numerator and denominator of function C of the higher value are stored (ST312). This calculation is repeated until i1 reaches two (the number of pulse position candidates) (ST305 to ST310).

When i0 is equal to or greater than eight and i1 is equal to or greater than two, the flow proceeds to step ST314 and search processing is finished.

Thus, although the sum of three position bits×5 and one polarity bit×5, namely, twenty bits are needed in a general algebraic codebook of five pulses, it is possible to represent the position and polarity with nine bits, which is less than half of twenty bits.

Further, by using the polarity information of the pulse of channel 0 in addition to its position information for calculations, although the amount of position information of pulse candidates of channel 1 is one bit, it is possible to determine a single position from eight positions. Therefore, it is possible to perform coding using limited information maximally.

Further, the position information of pulse candidates of channels 2 to 4 is uniquely determined from the position information and polarity information of the higher-channel pulse, and the pulse position is determined only by the polarity information. Therefore, it is possible to find excitation candidates of a predetermined channel from information about other channel excitation candidates and determine excitation information without bits, thereby determining an excitation comprised of a large number of channels fewer than the number of bits.

Further, as described above, the polarity of the outer loop (search loop 204) is determined upon searching for the inner loop (search loop 207), so that, by association and determination using the polarity, it is possible to increase the number of candidates of inner excitation. In the present embodiment, it is possible to produce five pulses by nine bits in all of the forty positions.

Further, as shown in the above-noted calculation example of position information, it is possible to find good performance by setting this position information calculating method such that code vectors are uniform (i.e., code vectors have randomness) in the vector space, as a result of the calculation. Mainly, good performance can be found based on the following three ideas.

First, upon using the same information, position information is assigned the different feature. To be more specific, different multiplied weights (such as “×2” and “×4” in the above-noted calculation example) are used every time (if features assigned to position information are the same upon using the same information, different pulses move in the same direction in the same way).

Second, the minimum number of items of information is used to secure randomness. This limits a range on which one information has an influence, eliminates the amount of calculations and reduces an influence of bit errors, and thus relates to performance.

Third, information that is used should be equally used, so that much position information does not depend on one information.

Thus, according to the present embodiment, by calculating in order from the position, polarity, correlation value and excitation power of a lower-channel pulse using the calculation result of a higher-channel pulse, it is possible to form an excitation vector having enough pulses from a small number of bits and acquire synthesis sound of high quality at a lower rate.

Further, although a method of calculating position information by computation has been described with the present embodiment, it is equally possible to calculate polarity information in the same way, for the same computation for position information needs only to be adopted to find the polarity. By finding the polarity by calculating higher pulse information, in theory, it is possible to produce a large indefinite number of pulses. However, uniquely determining the pulse polarity may actually cause the degradation of excitation quality, and therefore needs to be paid attention to. When the difference between the pulse polarity and the polarity of sequence pol[*] becomes greater, the level of degradation increases.

Further, although a case has been described with the present embodiment where the number of bits is nine and the processing unit (subframe length) is forty samples, it is equally possible to use other values, for the present invention does not depend on the information at all.

Further, although a case has been explained with the present embodiment where fixed codebook vectors of five pulses are used, combinations of any numbers of pulses are possible, for the present invention does not depend on the number of pulses at all.

Further, although a method of calculating pulse position information by residue and addition has been explained with the present embodiment, if the randomness of code vectors is acquired, it is equally possible to adopt other calculation methods. For example, bit operations such as AND (logical conjunction), OR (logical disjunction), and EXOR (exclusive disjunction), mutual multiplication, mutual division, function that generates random numbers, or combinations of these are possible.

Further, although an algebraic codebook is used as an example of a fixed codebook in the present embodiment, it is equally possible to apply the present invention to a multipulse codebook. This is because the position information and polarity information of multipulses are applicable to the present invention in the same way as above.

Further, although the present embodiment is applied to CELP, it is equally possible to apply the present invention to a coding and decoding method using a codebook storing the determined number of excitation vectors. This is because the feature of the present invention lies in a fixed codebook vector search, and does not depend on whether there is an adaptive codebook and whether the spectrum envelope analysis method is LPC, FFT or filter bank.

Although a case has been described with the above embodiments as an example where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

Further, the adoptive codebook used in explanations of the present embodiment is also referred to as an “adaptive excitation codebook.” Further, a fixed codebook is also referred to as a “fixed excitation codebook.”

The disclosure of Japanese Patent Application No. 2006-180143, filed on Jun. 29, 2006, including the specification, drawings and abstract, is incorporated herein by reference in its entirety.

### INDUSTRIAL APPLICABILITY

The speech coding apparatus and speech coding method according to the present invention can perform speech coding by a fixed codebook that efficiently uses bits and, for example, is applicable to mobile communication systems and mobile phones.

1. A speech coding apparatus for encoding by a fixed codebook an excitation comprising a plurality of separate channels, the apparatus comprising:
a first search section that searches for an excitation candidate of a first channel; and
a second search section that searches for an excitation candidate of a second channel using position information and polarity information of the searched excitation candidate of the first channel.

2. The speech coding apparatus according to claim 1, wherein the second search section searches for an excitation candidate of a third or later channel using position information and polarity information of an excitation candidate of a higher channel.

3. The speech coding apparatus according to claim 1, wherein the second search section performs inner loop processing of the first search section that performs loop processing.

4. A speech coding method for encoding by a fixed codebook an excitation comprising a plurality of separate channels, the method comprising:
a first search step of searching for an excitation candidate of a first channel; and
a second search step of searching for an excitation candidate of a second channel using position information and polarity information of the searched excitation candidate of the first channel.
